(19) United States
(12) Patent Application Publication
(10) Pub. No.: US 2025/0272756 A1
(43) Pub. Date: Aug. 28, 2025

(54) INITIATED AUTOMATIC CLAIM HANDLING THROUGH CONVERSATIONAL ARTIFICIAL INTELLIGENCE (AI)

(71) Applicant: State Farm Mutual Automobile Insurance Company, Bloomington, IL (US)

(72) Inventors: Theodore Edward Dorner, Sugar Hill, GA (US); Mahati Kakarla, Woodstock, GA (US); Sambasiva R. Murakonda, Cumming, GA (US)

(21) Appl. No.: 18/585,902

(22) Filed: Feb. 23, 2024

(51) Int. Cl. G06Q 40/08; H04L 51/02

(52) U.S. Cl. CPC G06Q 40/08; H04L 51/02

(57) ABSTRACT

A method for allocating resources of an organization for facilitating an electronic record in response to a weather-related event, that includes determining whether a client device is within proximity of an event; communicating with the client device to solicit messaging response data associated with the event; determining, by a processing engine, whether the client device will generate an electronic record associated with the event; applying an algorithm to compare the messaging response data from the at least one client device to stored data of electronic records; determining, based on aggregating messaging response data of the electronic record from at least one client device, a result of a number of electronic records to be generated at a locality in the proximity of the event; and determining at least one service from a plurality of services to be allocated to assist in facilitating a processing of electronic records.

### TECHNICAL FIELD

The present disclosure relates to using a generative messaging application, and more particularly to initiate automatically soliciting claim information from policyholders by enabling a dialogue with policyholders using a generative messaging application that is initiated in response to a large-scale event in which a significant number of claims are expected to be filed.

### BACKGROUND

Natural Language Processing (NLP) and Machine Learning (ML) usage are emerging in the insurance sector in applications to improve productivity in claims processing and to combat insurance fraud. For example, messaging applications may be adapted as conversational agents to interact with users for use in message-based claims processing.

Chatbots are a type of generative messaging application that may be implemented with automated systems to assist users by responding at all hours to user questions. For organizations such as an insurance company, chatbots can provide a convenient way to connect with policyholders twenty-four hours a day and seven days a week (e.g., 24/7), and this type of always-available assistance can increase customer satisfaction. For example, customer appeasement is increased by providing on-demand user-responsive communications by a chatbot and also allowing the ability to receive valuable feedback from policyholders' responses without incurring additional employee staffing costs.

Generative messaging applications (e.g., chatbots) may also be used to assist in certain tasks to discover policyholder or customer information. The information gleaned by chatbot interaction therefore not only assists the customer but in doing so can provide real-time data to an insurance company about insurance products. This in turn allows for the insurance company to benefit from the interaction by gaining access to the real-time information for use in providing existing and new insurance services.

### SUMMARY

Described herein are systems and methods to automatically initiate a conversation with a policyholder, based on weather data and/or Internet of Things (IoT) data indicating a claims-related event where policyholders may be expected to file claims in the near future. As described herein, the initiated automatically conversation or later after the event to enable the processing of the expected claims efficiently, and the allocating of resources for the processing of the claims in an impacted or affected region.

In some examples, a method is provided for allocating resources of an organization to assist at least one policyholder in facilitating an insurance claim in response to a weather-related event. The method includes communicating, by an application, to at least one policyholder identified in proximity to a weather event to solicit messaging response data from at least one policyholder related to an action of at least submitting an insurance claim associated with the weather event. In response to receiving the messaging response data from at least one policyholder, determining, using the application by inputting the messaging response data to an intelligent algorithm, a result of the likelihood of at least one policyholder submitting an insurance claim related to the weather event.

In an example, the intelligent algorithm may be configured to use a model to compare the messaging response data from at least one policyholder to stored data of policyholder insurance claim submissions. based on a comparison of the messaging response data to the stored data, determining, by application of the algorithm by aggregating messaging response data of the electronic record from at least one client device, a result of a number of electronic records to be generated at a locality in the proximity of the event. Then, based on the number of electronic records to be generated at the locality within the proximity of the event, determining at least one service from a plurality of services to be allocated to assist in facilitating the processing of electronic records at the locality associated with the event. For example, to aid in facilitating the processing of an insurance claim related to a weather event or other event.

In some embodiments, the method further includes automatic communication, by the application, to at least one policyholder using a generative messaging application such as a chatbot to solicit the messaging response data related to the weather event, to determine the likelihood that at least one policyholder will submit an insurance claim.

In some embodiments, the method further includes initiating a dialogue via a chatbot with at least one policyholder's chatbot to solicit the messaging response data related to the weather event to determine the likelihood that at least one policyholder will submit an insurance claim.

In some embodiments, the method further includes initiating a dialogue via the chatbot prior to, during, and after the weather event, to solicit messaging response data to determine the likelihood that at least one policyholder will submit an insurance claim.

In some embodiments, the algorithm applies a model that comprises a neural network with a set of nodes that comprise a first set of nodes trained on insurance claim data accessible at an operably coupled database storing policyholder claims, and a second set of nodes trained on data associated with data of at least the likelihood at least one policyholder will submit an insurance claim.

In some embodiments, the method further includes determining at least a location for setting up a mobile claims center based on the address data of at least one policyholder that has been identified in the proximity of the weather event.

In some embodiments, the method further includes generating, by the application, analytical data based on output from the intelligent algorithm that is related to the weather event and displaying, by the application, the analytical data in a graphical user interface (GUI) for presenting or viewing the allocation of resources for at least one policyholder that has been identified in the proximity of the weather event or other event.

In some embodiments, the method further includes receiving, by the application in operable communication with a plurality of weather data sources, weather-related event data; identifying, by the application, at least one policyholder in proximity of the weather event based on the weather-related event data; and displaying at least one of metric data related to the weather event, or personal available for the organization to provide at least assistance to facilitate processing of an insurance claim of the weather event.

### BRIEF DESCRIPTION OF THE DRAWINGS

The detailed description is set forth with reference to the accompanying figures. In the figures, the left-most digit(s) of a reference number identifies the figure in which the reference number first application appears. The use of the same reference numbers in different figures indicates similar or identical items or features.

FIG. 1 shows an example flow diagram of the initiated automatically conversational Artificial Intelligence (AI) system according to some embodiments.

FIG. 2 shows an example of a first and second phase of the process flow of the initiated automatically conversational AI system of FIG. 1 according to some embodiments.

FIG. 3 shows a diagram of the system architecture of phase 1 of FIG. 2 of the initiated automatically conversational AI system according to some embodiments.

FIG. 4 shows a diagram of the system architecture of phase 2 of FIG. 2 of the initiated automatically conversational AI system according to some embodiments.

FIG. 5 shows a diagram of an exemplary initiated automatically claim conversational AI dialogue of a chatbot with a policyholder of the initiated automatically conversational AI system according to some embodiments.

FIG. 6 shows a diagram of an exemplary claims intake system that integrates the content generated from the dialogue of the initiated automatically conversational AI system according to some embodiments.

FIG. 7 shows an exemplary set of graphical user interfaces (GUIs) that may be configured with the claims system of FIG. 6, according to some embodiments.

FIG. 8 shows an exemplary display in the real-time storm assessment and response dashboard of GUI of FIG. 7 according to some embodiments.

FIG. 9 shows an exemplary display of business insights through an intelligent search of the GUI of FIG. 7 according to some embodiments.

FIG. 10 shows a flowchart of an example method of the initiated automatic conversational AI system according to some embodiments.

FIG. 11 shows an example system architecture for a computing system that can initiate the automatically conversational AI system and provide information for use in determining how to allocate services or products of the insurance entity according to some embodiments.

### DETAILED DESCRIPTION

This disclosure describes techniques for using chatbots combined with other event data such as data from weather sources and data from Internet-of-Things (IoT) devices. In an embodiment, the techniques may include an initiated automatically conversation Artificial Intelligence (AI) system configured for receiving real-time weather data from weather sources, and data from IoT devices in an area impacted by a weather event and funneling this information to formulate a sequence of questions using automated AI chatbots that can be disseminated to mobile devices of an affected population of policyholders. In such examples, the AI chatbot can be used to solicit claims data from each policyholder using specific questions related to the weather or other events. The claims data that is received from the policyholders is then aggregated using machine learning solutions that can intelligently quantize the data to determine specific policyholder needs.

As customers in general, and insurance policyholders become more comfortable with interacting with messaging services such as chatbots; the use of chatbots will only become more ubiquitous in an insurance customer available toolkit presented by an insurance company to provide customer support. Further, the use of chatbots will likely gravitate from customary service use such as use by policyholders in soliciting claim quotes, and other mundane tasks (e.g., when is a payment due), to more sophisticated interactions. For example, insurance companies are likely to deploy their use in more aspects of the insurance lifecycle such as communicative tasks and interactions that today may be currently performed by employees.

The aggregated real-time information from the AI chatbot dialogue may also be relied upon to assist in logistics and allocation of company resources on the ground during, for example, a natural disaster. The aggregated claims data can be used in various models to plan and implement ground operations of the company to get immediate assistance in claim processing to the policyholders in an impacted area. This process can be used by an insurance company to allocate groups of personnel with the appropriate skills needed that are available and can reach out quickly to the affected policyholders. This may include staging on-the-ground operation locations with personnel and mobilizing on the ground a series of claims centers in the localities that are, have been, or may be affected.

In some examples, a method and system are provided that enables receiving information from one or more channels about environmental data and IoT data that may be indicative of a weather event. Determining using the initiated automatically AI conversation system, a set of policyholders in an area that may be impacted by the weather event. Initiate automatically, engaging with one or more policyholders in an impacted area, using an automated AI chatbot to communicate directly with one or more policyholders using a series of questions based on information received from the weather event and the IoT data where the questions may be configured using intelligent algorithms about the weather or other event. The system may aggregate data from the dialogue with the policyholders for processing sets of data. The system may apply one or more intelligent solutions based on the aggregated sets of data to determine the amount and type of company resources to be allocated in locations of the impacted areas to assist in the processing of claims by policyholders. The system may apply generative AI solutions based on the aggregate data to enable improved and more useful dialogue by the AI chatbot with policyholders in the impacted or affected region.

It is desirable to use automated messaging services such as chatbots to initiate and gather real-time information from dialogues or interactions with policyholders with more personalized and time-sensitive communications.

It is desirable to use an automated messaging service to initiate and automatically assist a group of policyholders who are likely impacted as a result of a weather event or other disaster event requiring insurance claim support.

It is desirable to use an automated messaging service by an insurance organization to enable efficient processing of a deluge of claims predicted by policyholders in an impacted region from a weather event.

It is desirable to use an automated messaging service to prevent an overload of resources available in an impacted region of policyholders and an expected large number of claim submissions that may exceed normal operating capacities that are being provided for customer support.

The systems and methods described herein may be at least directed toward using automated chatbots initiated based on monitoring of certain event data such as data from weather sources, and data from Internet of Things (IoT) devices to facilitate initiate automatic entering into a dialogue with a likely impacted or impacted policyholder for processing of electronic records or claims by the likely impacted or impacted policyholder in an affected region.

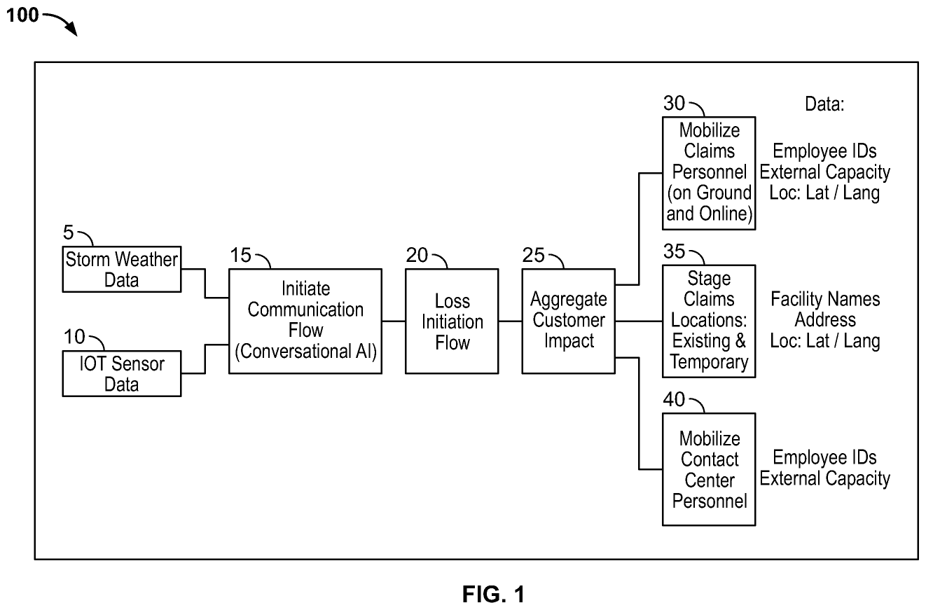

FIG. 1 shows an example flow diagram of the initiated automatically conversational AI system according to some embodiments. In FIG. 1 in the initiated automatically conversational AI system (“proactive conversational system”) 100, at block 5, event data such as weather data may be received for monitoring of weather events and weather-related events in localities that the corporate entity (e.g., insurance company) provides coverage. At block 10, sensor data from the Internet of Things (IoT) device (e.g., household-connected devices) may be generated and can also be received in tandem (or independently) with the weather data of block 5, and both the IoT data and the weather or environmental data may be indicative of weather events or used to determine weather or other events by the initiated automatically conversational AI system 100. The weather data may be received from a number of sources including weather information from external sources such as NOAA and FEMA, and also from internal data sources. The IoT information may be received from monitoring systems such as those of a homeowner networked device or security service that may have been locally installed on the premises.

At block 15, based on the continuous monitoring of the data that is being received (from the sources of block 5, and block 10), the initiated automatically conversational AI system 100 unilaterally or independently initiates communicating (e.g., messaging or voice calling) with a select group of policyholders or users. For example, based on locality information from profile data that an insurance policy provides to the insurance company and correlating or matching of the policyholder's profile information or the address information used in a policy that has been underwritten, a group of policyholders to be contacted is determined. The contact may be initiated independent of a policyholder's requests and prior to, during, or after a weather event or other type of event in which the policyholder is determined to be likely or foreseeably filing a claim to the insurance company (e.g., an electronic record, submitting a request, making communication with the insurance company).

At block 20, a loss initiation flow or process is executed by the initiated automatically conversational AI system 100. In implementation, the initiated automatically conversational AI system 100 may execute a messaging application such as an AI or regular chatbot to communicate with a policyholder or other user to get information about or surrounding the weather event. The type of communication is not limited to a (AI) chatbot but may be a mixture of voice and messaging communications with a select group of policyholders. The communications may also be expanded to include non-policyholders to get information such as local emergency service providers.

In some examples, a chatbot application is executed that poses a series of questions to the policyholder about a weather event or other event to determine if the policyholder wants or will be filing a claim. The series of questions may be specific to the weather event or other events or maybe general questions. Further, the questions may be based on information gleaned from third-party services such as regenerative AI services including CHATGPT®, GOOGLE® BARD, and other like services. The series of questions may be specific to the policyholder based on information from the policyholder's contract or policy and the terms of the policy such as the coverage obtained by the policyholder. The series of questions may allow the policyholder to respond with images captured using an electronic device as well as allow for audio or voice responses. The chatbot application may also be able based on responses to change the communication path to other devices, and other users to continue a dialogue of the series of questions to other parties upon the policyholder granting such rights or extending such rights of communication.

In some embodiments, at block 25, the information from the series of questions is transcoded or ingested into a format that allows for further annotating and labeling of data objects captured in the communications. The data object may as an example be aggregated and analyzed using an intelligent algorithm. In some embodiments, the data object may be orchestrated using a number of microservices to derive information such as NLP services, and comparisons with claim data (i.e., electronic records or files about claims) in connected repositories and databases.

In some embodiments, at block 25, the initiated automatically conversational AI system 100 applies an intelligent algorithm that uses a classification engine to aggregate data of policyholder (e.g., customer) messaging response data that has been collected and is being collected by the initial and ongoing dialogue that the messaging service, the chatbot, is performing; that is communicating with the select group of policyholders in proximity to the weather or impacted event. The initiated automatically conversational AI system may enable the classification engine that include a neural network that is modeled with multiple layers of nodes. In an embodiment, a first set of nodes is trained on the content of inputted past claim (record) submission data, and another set of nodes is trained on inputs of attribute data that relate to the likelihood that a policyholder in a vicinity of weather or other events will submit a claim (e.g., the age of the policyholder, the finances of the policyholder, etc.). In some embodiments, the algorithm (e.g., an intelligent or smart algorithm such as a neural network) of the classification engine may generate one or more outputs that include representations and analysis of data that present mappings and other metrics to make decisions by the insurance entity (or other organization) of how to provide services that can be made available for policyholders. For example, the type of services may include at block 30 the mobilizing of personnel for on-ground and online claims processing; at block 35, the staging of personnel at locations about a weather-related event, or other large-scale event having insurance claims; at block 40, the mobilizing of the contact center with personnel and the available number of resources that are on hand and the insurance entity can provide.

In various embodiments, the output of the classification engine (processing engine) may also include filtering and identifying claims that are not consistent with claims in progress for identifying fraud claims. For example, a smart or intelligent algorithm may be configured to generate a profile of likely claim submissions given the weather-related information and use this template to determine claims that are an anomaly or not in line with claims being submitted for further inspection by personnel and classifying as possibly fraudulent. In this way, resources are not allocated to claims that are deemed to be inadmissible faster as in a weather event or other natural disaster there may deluge of claims making such identification less likely to be identified early in the claim processing.

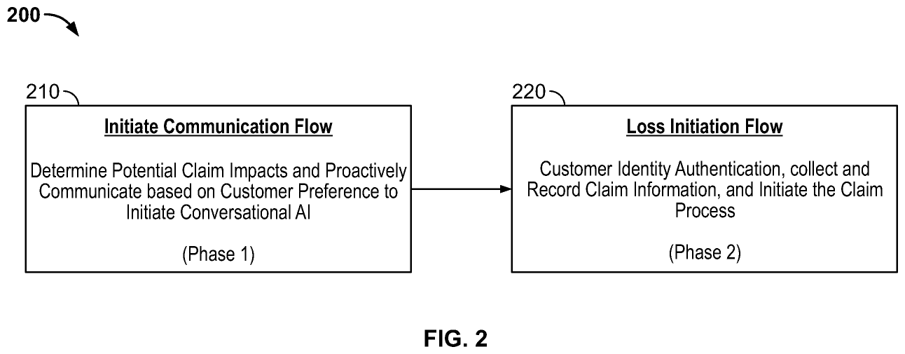

FIG. 2 shows an example of the first and second phases of the process flow 200 of the initiated automatically conversational AI system 100 of FIG.1 according to some embodiments. In FIG. 2, the process flow includes block 210 of “phase 1” or an “initiate communication flow” to determine the potential claims impacts and initiate automatic communications based on customer preferences to initiate conversational AI. In phase 1, the initiated automatic (proactive-talking) conversational AI system 100 may be configured to apply the intelligent algorithm to determine the potential claim impact and initiate based on a customer preference for a conversational AI agent (e.g., AI chatbot). The AI chatbot may incorporate regenerative AI applications. The AI chatbot may be configured using a processing engine (a classifying engine) that uses a neural network that is trained with multiple sets of nodes such as a first set of nodes trained on past claims data, a second set trained on past user profile data of likely claim submissions, and a third set of preferences for receiving a company-initiated communication or interaction. In some embodiments, the training of the AI chatbot may provide prefaced questions based on the event, including templates and pick-and-choose objects that have been generated to assist in the policyholder submitting a claim.

In some embodiments, the AI chatbot may continually adjust (or change) the dialogue based on previous or parallel or other dialogues related to the event and changes in the event data, with similarity or not to dialogues that have been executed with other parties and policyholders. In some embodiments, phase 1, may include automatically using AI algorithms adjusting the responses and/or input received from a policyholder and representing a preview for the policyholder to agree to. In this way, the integrity of the responses is improved and errors are caught in the responses provided by the policyholder (that are not usual given the circumstances of a weather disaster event). In some embodiments, the AI chatbot may provide written documentation of the dialogue and generate an electronic file or claim to be sent via email or text message to the policyholder.

Continuing to refer to FIG. 2, at block 220, at “phase 2” a loss initiation flow is executed by the initiated automatically conversational AI system 100 in which the customer identity is authenticated and electronic record claim information is collected/generated to initiate the claim process. In phase 2, the AI chatbot may authenticate using either messaging statements and questions, two-step authentication processes that have been already set up by the policyholder, and/or voice responses and other biometrics. Once the authentication process is completed and recorded, a dialogue is initiated (online) that is recorded. In some examples, a lockdown browser may be used to protect the integrity of the responses. The dialogue with specific responses that elicit a likely response on the part of the policyholder where each statement may be vetted using a neural network to determine a likely response and if this response is what is needed. In other words, the dialogue isn't simply a descriptive type of dialogue but one that is industry-specific, that is configured using past claims data, and filtered by the processing engine of the initiated automatically conversational AI system 100. In some embodiments, a repeated for confirmation may include the value estimates of the damage and the type of damage to better quantify the value of the damage when it is later reviewed by a claims adjuster.

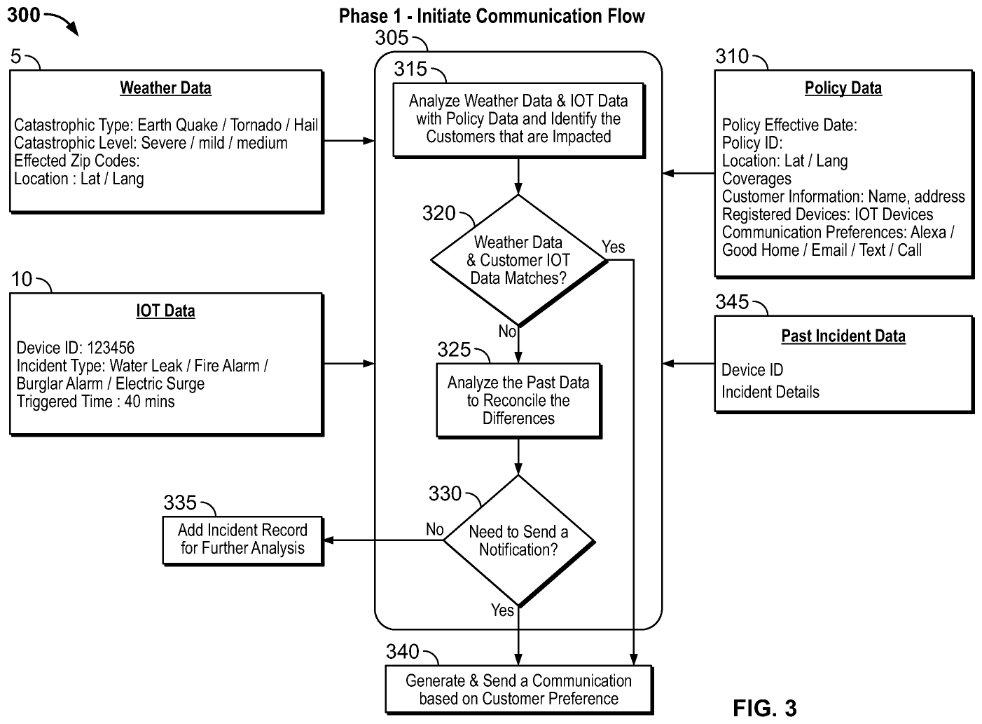

FIG. 3 shows a diagram of the system architecture 300 of phase 1 of FIG. 2 of the initiated automatically conversational AI system 100 according to some embodiments. In FIG. 3, there is shown module 305 including one or more processing engines configured to process the inputted data from weather sources (Block 5 of FIG. 1), IoT data (block 10 of FIG. 1), and policy data at block 310 with past incident data (past electronic record or claim data) at block 345.

In some embodiments, the weather data of the source block 5 may further include catastrophic weather data such as data from an earthquake, a tornado, or hail that is associated with various levels or scales of severe, medium, and mild, with the latitude and longitude geographic information corresponding to the weather data. The IoT data of the sources of block 10 may further include a device identifier of the IoT device, type of incident (e.g., water leak, fire alarm, burglar alarm, electric surge), and time of triggering of the incident by the IoT device. The policy data of block 310 may include data such as the effective date that the policy is or was in effect, policy identifiers, location data including latitude and longitude of the policy coverage region, policyholder address information, registered IoT devices, and communication preferences such as AMAZON® Alexa and Goods, email, text, calling. The past incident data of block 345 includes incident or claim details, results of claim assessment, device identifiers, and other related information that may be useful in correlating and training the machine learning model (neural network) of the intelligent algorithms of the processing engines.

In various embodiments, module 305 for receiving the multiple imputed data types is configured (at step 315) with a processing module to initially receive the inputs from the sources of the weather data (block 5), the IoT data (Block 10) and the policy data (Block 310) in a processing pipeline, to analyze the environmental conditions based on real-time inputs of the weather data and the IoT data, and to combine this data analysis with policyholder specific data from block 310. In some embodiments, the processing module at step 315 is configured to use various machine learning algorithms and apply intelligent models to determine one or more classes or groups of policyholders that will be impacted immediately, in the near future, or at a later date by the weather or related event.

For example, at step 320, an analysis of the weather and IoT data is performed to discover matches with policyholder locations and to identify various sets of policyholders that will or are impacted by the current or expected weather event. Once the policyholder impacted group has been determined or identified using the machine learning algorithms, an additional analysis is performed at step 325 to discover related past electronic records or claim submissions from past incident data (input from sources of block 345). If matches of related (historic) records are discovered and determined, the date from matched electronic records or claims is analyzed to reconcile differences and to decide what questions to put forth via the AI chatbot. This may include one or more notifications (at step 330) to be sent to the policyholders about the weather event and to assist the policyholder in considering initiating a claim submission. At step 330, if it is decided not to send any notifications to the policyholders, then at step 335, data is added to an incident or an electronic record for further analysis or reviewing at a later time or may be removed. At step 330, if it is decided to issue a notification, then at step 340 a notification is sent to the policyholder (the customer) based on the policyholder's preset communication preferences or by default communication if no preferences have been set.

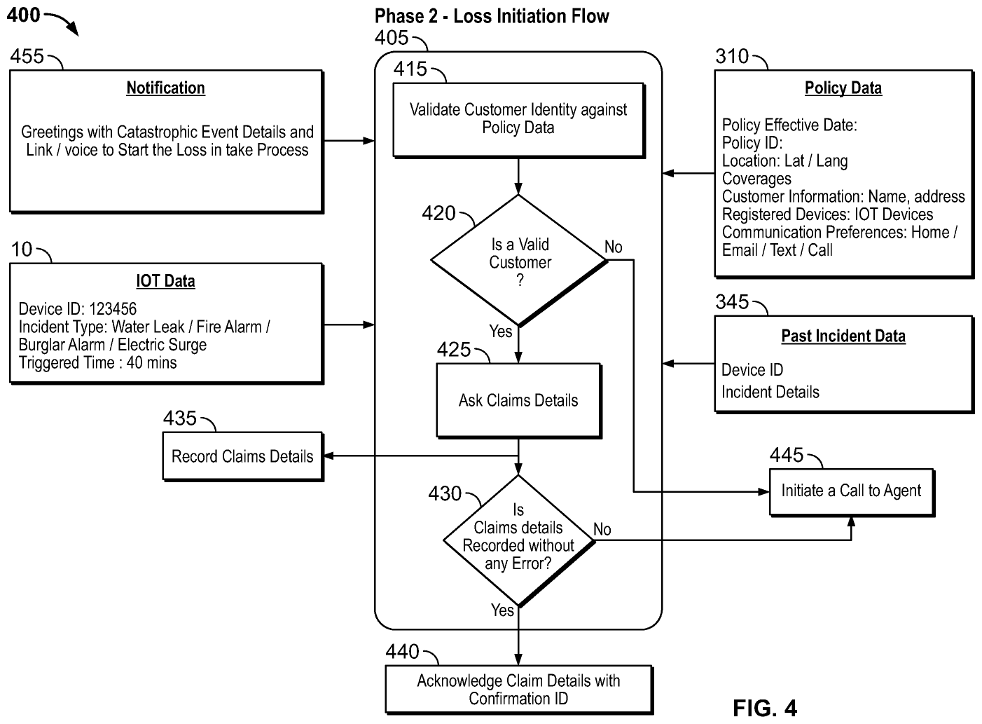

FIG. 4 shows a diagram of the system architecture 400 of phase 2 of FIG. 2 of the initiated automatically conversational AI system 100 according to some embodiments. In FIG. 4, there is shown module 405 of the system architecture 400 which includes one or more processing engines configured to process the inputted data from notifications by weather sources of block 455, IoT data (block 10 of FIG. 1), and policy data at block 310 with past incident data (past electronic record or claim data) at block 345. The notifications by the weather sources of block 455 may include the initiated automatically conversational AI system receiving or generating text-based notifications. For example, the text-based notification may be a greeting with details of a “catastrophic” weather event and hyperlinks for navigating to other sources of details of the catastrophic event. Also, audio and video files may be embedded in the text messaging to present other media details. The notification can be used as a way to initiate to the policyholder the rationale for engaging with one or more policyholders in an impacted area and a prelude to initiating the dialogue by the AI chatbot.

Module 405 includes a processing step, at step 415 to validate the policyholder's (customer) identity using the policy data shown in block 310. For example, the policyholder may be authenticated and validated at step 420 as a policyholder by a series of questions and responses, as well as a two-step authentication process flow. Once authenticated and validated at step 415, the initiated automatic conversation AI system generates at step 425 a series of questions to investigate and probe into details about the likelihood that the policy is or will be impacted by the weather event or another event. The series of questions that are raised are generated in a manner to engage the policyholder and to ferret material details in the least obtrusive way (so as not to be deemed offensive) and most efficient manner. For example, questions may be generated that require only mono-symbolic responses (e.g., “yes” or “No”). The questions may be leading in which details of the weather event and potential impact to the policyholder are created based on the details of the policy coverage, and intelligent algorithms that determine the potential damage or impact of the weather event (e.g., a storm, flood, high winds) that the policyholder is likely to experience. In some examples, the initiated automatically conversational AI system may aggregate data or content-based information from dialogue already performed with other policyholders in the proximity of the weather event who may have been impacted by the weather event, and apply intelligent algorithms or solutions based on the aggregated data and information in questions posed in the dialogue engaged with the policyholder.

At step 420, if it is determined that the policyholder is not a valid or authenticated policyholder then the system may initiate a call, at step 445, to an agent or specialist assigned to the weather event to perform a more thorough authentication or troubleshoot the issue of the policyholder not being able to be authenticated. At step 430, the electronic record is checked for errors by comparing the data record in the dialogue and the information extracted to the policy data (block 310) contained in an electronic record associated with the policyholder and/or information that the system has learned about the weather event from different sources independent of the current dialogue with the policyholder. If any of the responses of the policyholder appear to be out of place or do not fit in a pattern of expected response as determined by one or more intelligent algorithms applied, the system may ask again the question or ask for clarification for a response (at step 440). In some examples, regenerative AI algorithms may be applied to correct an error, and the generated error correction in the electronic record or claim may be presented to the policy for confirmation.

At step 435, the claim may be recorded. In some embodiments, the claim or electronic record may be recorded in a blockchain and the blockchain record may be updated as more information is received from a continued policyholder. In this way, a permanent record is created about the claim and protects against changes in the electronic record or file history against changes in the history of the record creations.

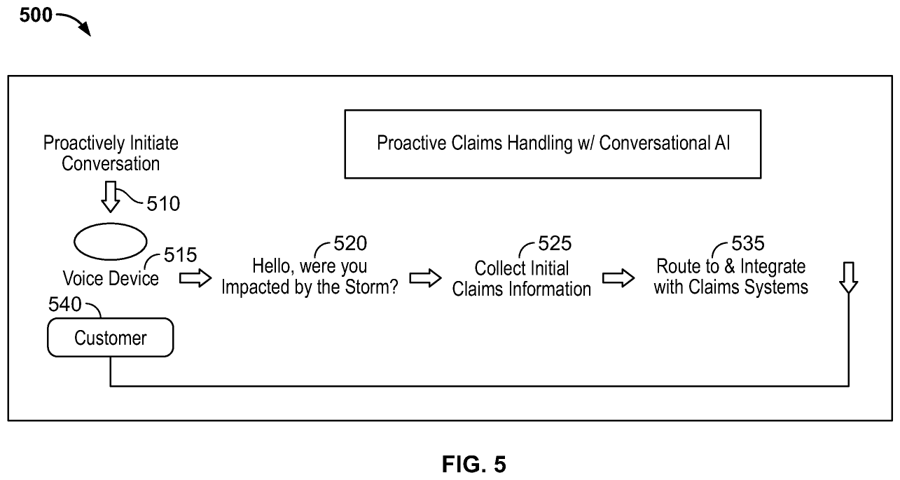

FIG. 5 shows diagram 500 of an exemplary initiated automatically claim conversational AI dialogue of a generative messaging application (e.g., a chatbot) with a policyholder of the initiated automatically conversational AI system according to some embodiments. In FIG. 5 the initiated automatically conversational AI system 100 (of FIG. 1) takes the initiative at step 510 and automatically initiates a conversation in a modus operandi using a voice-activated device. The conversation may be initiated via a messaging application on the mobile device of the policyholder or via an email link sent to the policyholder. At 515, a voice-activated device (e.g., an AMAZON® ALEXA or GOOGLE® Home) may initiate the dialogue of an AI chatbot of the initiated automatically conversational AI system 100. At 520, as part of the initiated conversation, a question from the AI chatbot may be posed at step 520 such as “Hello, were you impacted by the storm?” to elicit a response from the policyholder. At step 525, the AI chatbot may receive a response and begin the collection of initial claim or electronic record information. At step 535, the initiated automatically conversational AI system may route and integrate the information collected into a claims system for storing, further analysis, and claim determinations. At step 540, the system may respond with additional information received from the claims system to the customer or policyholder.

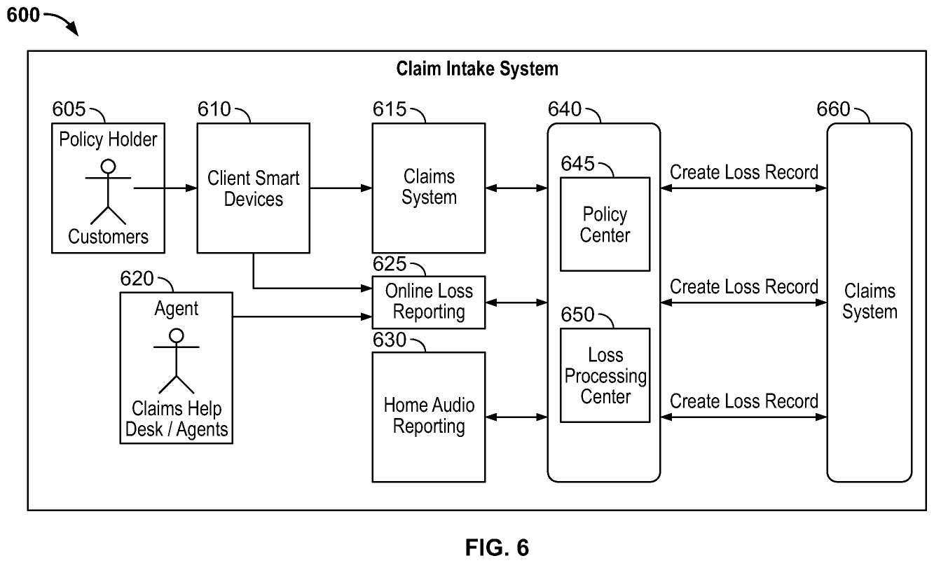

FIG. 6 shows a diagram of an exemplary claims intake system that integrates the content generated from the dialogue of the initiated automatically conversational AI system according to some embodiments. FIG. 6 illustrates a high level of the process flow of the claim intake system that includes some of the elements to illustrate the integration between the initiated automatic conversational AI system and the claim intake system 600. In some embodiments, the claim intake system 600, the policyholder 605 communicates with a smart home device (client device) 610 such as the AMAZON ALEX® to enter into a dialogue initiated by the initiated automatically conversational AI system 100. The content and data associated with the dialogue including the voice files and metadata are sent or streamed to the claims system 615. In some embodiments, the claims system 615 is integrated with module 640 contains policy data at policy center 645, and processes losses from claims at loss processing center 650. In some embodiments, an agent 620 communicates with the smart home device 610 and the policyholder 605, and a receiving device 630 records content from the agent 620 and the smart home device 610. An online loss reporting device 625 records information about losses from the smart home device 610 and the agent 620. The outputs from these devices are sent to a loss processing center 650 (outputs from online loss reporting device 625 and audio reporting device 630) for creating a number of electronic records that include actual and predicted loss records that are subsequently sent to the claims system 660.

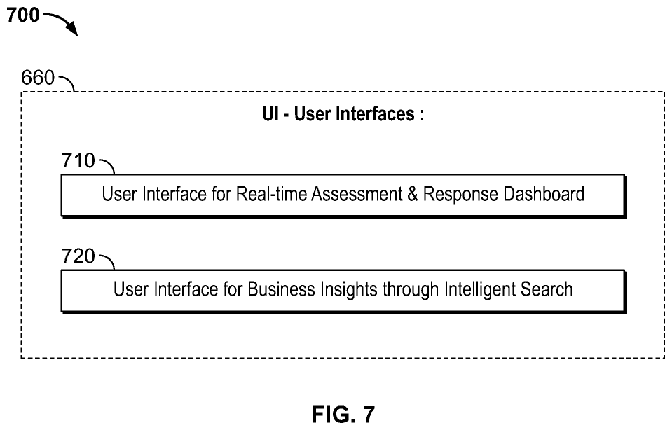

FIG. 7 shows an exemplary set of graphical user interfaces (GUIs) 700 that may be configured with the claims system 600 of FIG. 6, according to some embodiments. In FIG. 7, the GUI 710 provides a display of real-time damage assessments and responses currently allocated to the insurance that is assisting with claims processing for a group of policyholders that have been impacted by a weather event. In some embodiments, the real-time assessment is in constant flux requiring adjustments of the type and number of resources that need to be allocated. In some embodiments, the response dashboard may identify policyholders generically using latitude and longitude information from policyholders' profiles. In some embodiments, the real-time assessment includes content derived from the analysis of responses in a dialogue of the AI chatbot that has been initiated with an identified group of policyholders impacted by the weather event.

In some embodiments, the response dashboard includes locations of mobile centers set up and staffing of resources for the centers in an impacted region. The GUI 720 includes business insights that may be queried by a user of metrics that include losses, payouts, future payouts, statuses of claims processing, claims predicted, claims not paid out, and claims identified that may require investigations. Also, the GUI 720 may include aggregated data of attributes of policyholder claims submitted in an impacted region. The description of the items displayed in the GUIs 710 and 720 are exemplary and it is contemplated that a variety of different items may be displayed and navigated too in each GUI. Further, versions of the displays configured in each GUI of items shown are modifiable and may be accessible on a desktop display or by a mobile device.

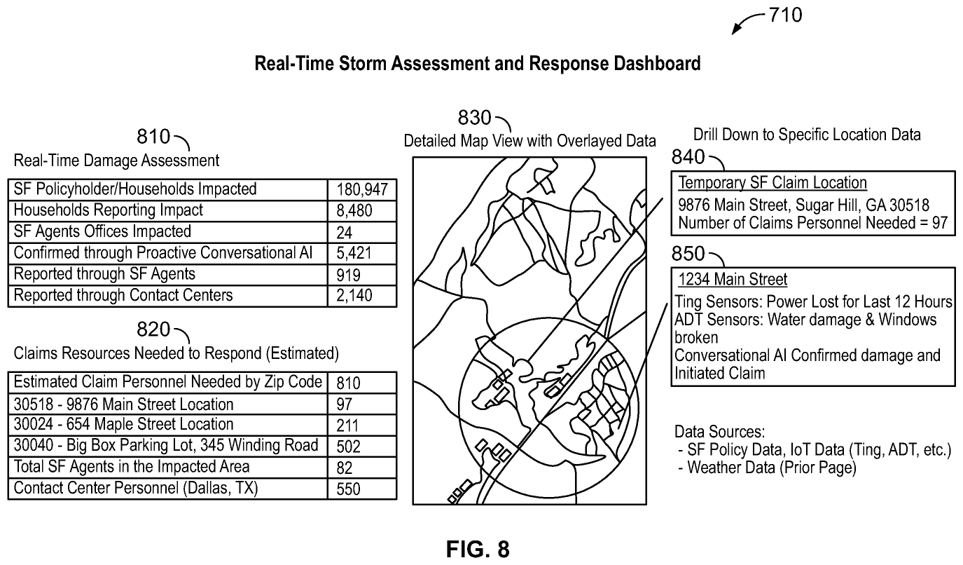

FIG. 8 shows an exemplary display in the real-time storm assessment and response dashboard of GUI 710 of FIG. 7 according to some embodiments. In FIG. 8, screenshot 800 shows GUI 710 of the real-time storm assessment and response dashboard that includes the displays of display 810 of real-time damage assessment, display 820 of claims resources needed to respond, display 830 of a detailed map view with overlayed data, display 840 of a drilled down view of a specific location address and related data, and display 850 of another drilled down view of a specific location address and related data.

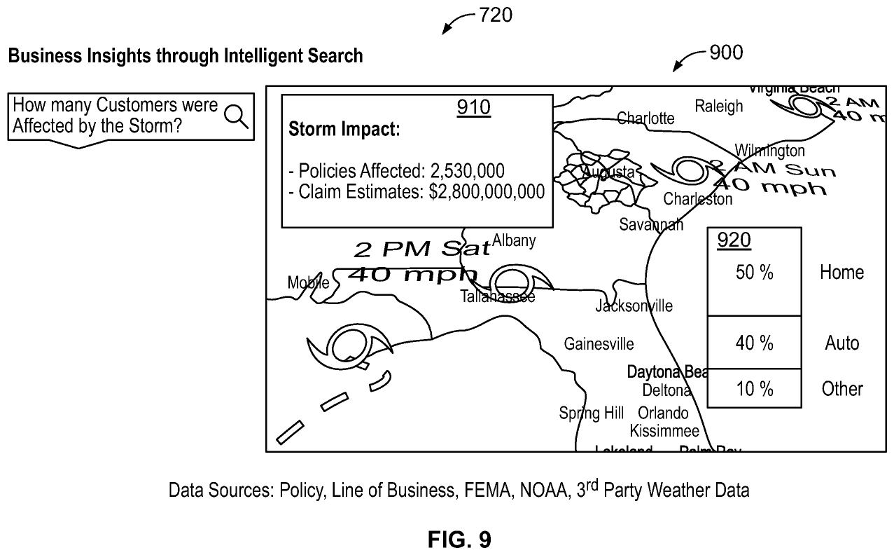

FIG. 9 shows an exemplary display of business insights through an intelligent search of GUI 720 of FIG. 7 according to some embodiments. FIG. 9 shows screenshot 900 of the GUI 720 of the business insight metrics of an impacted region that includes the storm impact policies affected and claim estimates (block 910). Also shown is a classification of the home, auto, and other policies affected (block 920) overlaid on a geographic map of an impacted region.

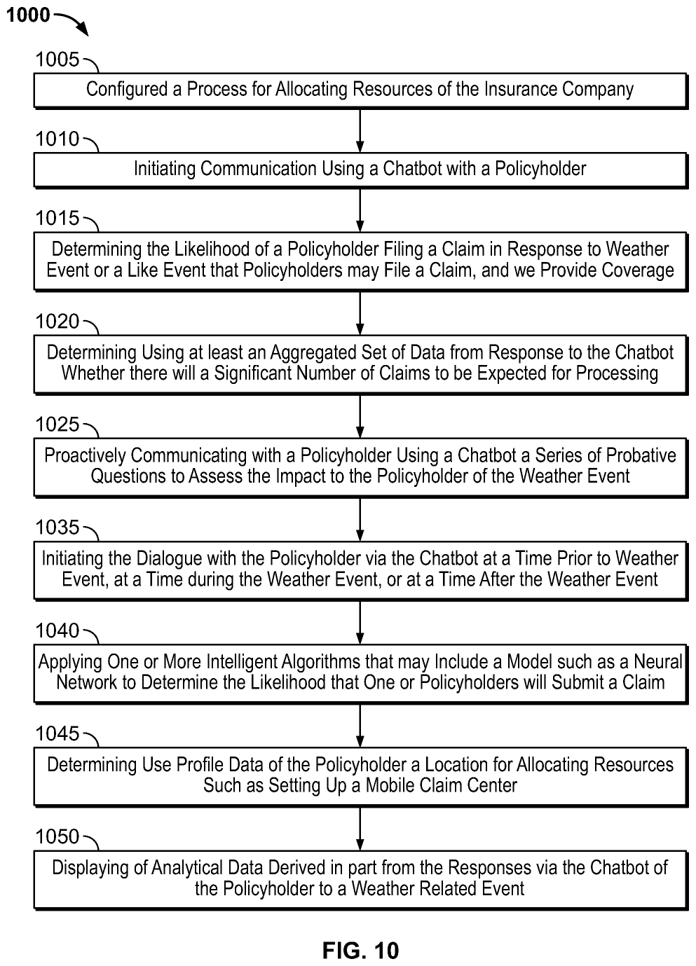

FIG. 10 shows a flowchart of an example method of the initiated automatic conversational AI system according to some embodiments. In FIG. 10, flowchart 1000 includes the steps of a process of determining of policyholder's mobile device within the proximity of a weather-related event and initiating a dialogue with the policyholder using an automated messaging application that is initiated automatically by the claim processing system of the insurance organization in response to notification and determination of the weather-related event will likely have an impact on a group of policyholders. In some examples, a user using a mobile device can enter into a dialogue with the generative messaging application such as an AI Chatbot which is initiated automatically by the conversational AI system 100 (of FIG. 1). The generative messaging application may be downloaded from GOOGLE® Play, APPLE® Play, or any other application depository.

The conversational AI system 100 may be configured to perform a number of operations described in the flowchart 1000 that include response to receiving the messaging response data from the policyholder's device, of determining, by a processing engine hosted by a computing device such as a server and by inputting the messaging response data to the processing engine, whether the policyholder's device will be generating a claim such as an electronic record associated with the event. The conversational AI system may be applied by the processing engine, an algorithm to compare the messaging response data from at least one client device to stored data of electronic records and based on a comparison of the messaging response data to the stored data, determine by application of the algorithm based on aggregating messaging response data of the claim (e.g., the electronic record from policyholder client devices, a result of a number of claims to be generated at a locality in the proximity of the event. Also, based on the number of claims to be generated at the locality within the proximity of the event, determine a service amongst multiple services to be allocated to assist the policyholder impacted by the weather event in facilitating the processing of claims at the locality of the weather event.

In FIG. 10, at step 1005, a method is configured for allocating resources of an organization such as an insurance company to assist at least one policyholder in facilitating an insurance claim in response to a weather-related event. At step 1010, the initiated automatically conversational AI system 100 initiates communication to at least one policyholder identified in proximity to a weather event to solicit messaging response data from at least one policyholder related to at least submitting an insurance claim associated with the weather event. At step 1015, in response to receiving the messaging response data from at least one policyholder, the initiated automatically conversational AI system 100 determines by inputting the messaging response data to an intelligent algorithm, a result of a likelihood of at least one policyholder submitting an insurance claim related to the weather event. The intelligent algorithm uses a model to compare the messaging response data from at least one policyholder to stored data of policyholder insurance claim submissions. At step 1020, the initiated automatically conversational AI system 100 determines, based on a result associated with the likelihood of at least one policyholder submitting an insurance claim related to the weather event and by at least aggregating messaging response data of a likelihood of insurance claim from at least one policyholder, at least one service from a plurality of services to be allocated by the organization to assist to facilitate the processing of an insurance claim related to a weather event. At step 1025, the initiated automatic conversational AI system 100 automatically initiates (e.g., proactively talks) and communicates to a policyholder using a generative messaging application such as a chatbot to solicit the messaging response data related to the weather event and to determine the likelihood that at least one policyholder will submit an insurance claim.

At step 1030, the initiated automatically conversational AI system 100 initiates a dialogue via a generative messaging application such as a chatbot with policyholders where the chatbot solicits messaging response data from the policyholders about the impact of insured items and damage from the weather event to determine the likelihood that a policyholder will submit an insurance claim, and if there is coverage for the claim that the policyholder will likely file. At step 1035, the initiated automatically conversational AI system 100 initiates a dialogue via the chatbot at a time prior to, during, and after the weather event, to solicit messaging response data to determine the likelihood that at least one policyholder will submit an insurance claim. At step 1040, the initiated automatically conversational AI system 100 may apply an intelligent algorithm that may be configured with a model that includes a neural network with multiple sets of nodes. The neural network may be configured with a first set of nodes trained on insurance claim data accessible at an operably coupled database policyholder, and a second set of nodes trained on data associated with data of at least the likelihood at least one policyholder will submit an insurance claim.

At step 1045, the initiated automatically conversational AI system 100 may determine using profile data of the policy, weather data, and IoT data, a location for setting up a mobile claims center based on address data of at least one policyholder that has been identified in proximity of the weather event. At step 1050, the initiated automatically conversational AI system 100 may provide information for displaying analytical data within a graphical user interface based on output from the algorithm (e.g., an AI or intelligent algorithm such as a neural network) that is related to the weather event; and the analytical data may be displayed in a graphical user interface for presenting the allocations of resources for the policyholders that have been identified in the proximity of the weather event. Also displayed in the graphical user interface may be dynamic changes in demand responsive to a number of claim submissions and the locality of the claim submissions for providing visual cues to change the allocation of resources available within the proximity of the event.

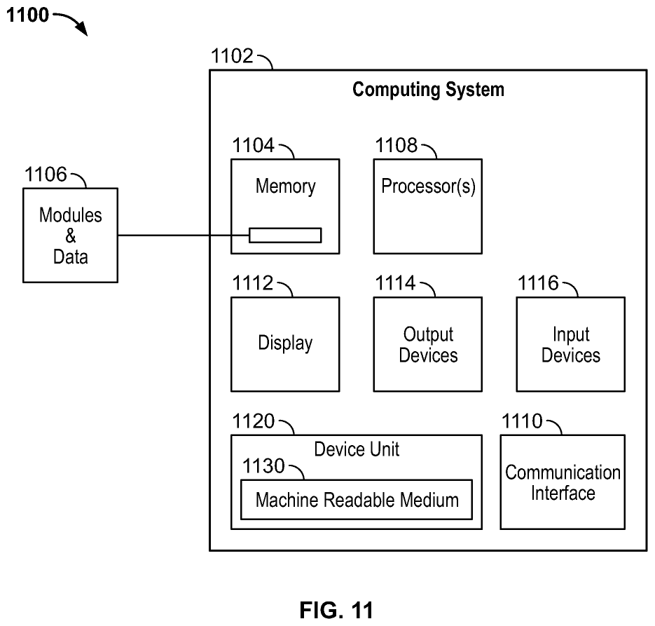

FIG. 11 shows an example system architecture 1100 for a computing system that can initiate the automatic conversational AI system and provide information for use in determining how to allocate services or products of the insurance entity according to some embodiments. In FIG. 11, the computing system 1102 can be configured at a server or desktop that is operably coupled to a mobile device and can include memory 1104. In various examples, the memory 1104 can include system memory, which may be volatile (such as RAM), non-volatile (such as ROM, flash memory, etc.), or some combination of the two. The Memory 1104 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system 1102 associated with the initiated automatically conversational AI system. Any such non-transitory computer-readable media may be part of the computing system 1102.

The memory 1104 can store modules and data. The modules and data can include data and/or software or firmware elements, such as data and/or computer-readable instructions that are executable by one or more processors 1108. For example, memory 1104 can store computer-executable instructions and data associated with the various elements of the initiated automatically conversational AI system described, such as data and/or computer-executable instructions associated with the initiated automatically conversational AI system and/or other elements described herein. The Memory 1104 can also store other modules and data 1106, such as any other modules and/or data that can be utilized by the computing system 1102 to perform or enable performing any action taken by the computing system 1102. Such other modules and data 1106 can include a platform, operating system, and application locations, and data utilized by the platform, operating system, and application locations.

The computing system 1102 can also have processor(s) 1108, communication interfaces 1110, a display 1112, output devices 1114, input devices 1116, and/or a drive unit 1120 including a machine-readable medium 1130.

In various examples, the processor(s) 1108 can be a central processing unit (CPU), a graphics processing unit (GPU), both a CPU and a GPU, or any other type of processing unit. Each of the one or more processor(s) 1108 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 1108 may also be responsible for executing computer applications stored in memory 1104, which can be associated with common types of volatile (RAM) and/or nonvolatile (ROM) memory.

The communication interfaces 1110 can include transceivers, modems, interfaces, antennas, telephone connections, and/or other components that can transmit and/or receive data over networks, telephone lines, or other connections. In some examples, the communication interface 1110 can be used by the initiated automatic conversational AI system 100.

The display 1112 can be a liquid crystal display, or any other type of display commonly used in computing devices. For example, a display 1112 may be a touch-sensitive display screen and can then also function as an input device or keypad, such as for providing a soft-key keyboard, navigation buttons, or any other type of input.

The output devices 1114 can include any sort of output devices known in the art, such as the display 1112, speakers, a vibrating mechanism, and/or a tactile feedback mechanism. Output devices 1114 can also include ports for one or more peripheral devices, such as headphones, peripheral speakers, and/or a peripheral display.

The input devices 1116 can include any sort of input devices known in the art. For example, input devices 1116 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable medium of the drive unit 1120 can store one or more sets of instructions, such as software or firmware (including a neural network), which embody any one or more of the methodologies or functions described herein. The instructions can also reside, completely or at least partially, within the memory 1104, processor(s) 1108, and/or communication interface(s) 1110 during execution thereof by the computing system 1102. The memory 1104 and the processor(s) 1108 also can constitute machine-readable media.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method for facilitating an electronic record in response to an event, comprising:
determining, by a server, at least one client device within a proximity of an event;
communicating, by a server, with the at least one client device to solicit messaging response data from the at least one client device associated with the event;
in response to receiving the messaging response data from the at least one client device, determining, by a processing engine of the server, inputting the messaging response data to the processing engine, whether the at least one client device will generate an electronic record associated with the event;
applying, by the processing engine, an algorithm to compare the messaging response data from the at least one client device to stored data of electronic records;
based on a comparison of the messaging response data to the stored data, determining, by application of the algorithm based at least on aggregating messaging response data of the electronic record from at least one client device, a result of a number of electronic records to be generated at a locality in the proximity of the event; and
based at least on the number of electronic records to be generated at the locality within the proximity of the event, determining at least one service from a plurality of services to be allocated to assist in facilitating a processing of electronic records at the locality associated with the event.

2. The method of claim 1, wherein
communicating with the at least one client device using a generative messaging application to solicit the messaging response data related to the event.

3. The method of claim 2, further comprising:
wherein the generative messaging application is a chatbot; and
initiating a dialogue via the chatbot based on a determination that the at least one client device will generate an electronic record.

4. The method of claim 1, wherein communicating with the at least one client device comprises:
initiating a dialogue via a chatbot to a policyholder associated with a client device, to solicit the messaging response data associated with the event, wherein the dialogue is initiated based on a determination that the policyholder associated with the client device will be generating an electronic record.

5. The method of claim 1, wherein the algorithm applies a model that comprises a neural network with a set of nodes that comprise a first set of nodes trained on electronic record data, and a second set of nodes trained on data indicative of a policyholder associated with a client device will be submitting an electronic record.

6. The method of claim 1, further comprising:
determining a location for setting up a mobile resource center based on address data of the at least one client device that has been identified in proximity of the event.

7. The method of claim 1, further comprising:
generating, by the server, analytical data related to the event, based on output from the algorithm; and
displaying, by the server, the analytical data in a graphical user interface for presenting an allocation of resources available within proximity of the event.

8. The method of claim 7, further comprising:
receiving, by the server and from a data source, additional event-related data; and
displaying, within the graphical user interface, dynamic changes in demand responsive to a number of electronic record submissions and locality of electronic record submissions for changing the allocation of resources available within the proximity of the event.

9. A system, comprising:
at least one memory; and
at least one processor coupled to the at least one memory, wherein the at least one processor is configured to:
determine of at least one client device within a proximity of an event;
communicate with the at least one client device to solicit messaging response data from the at least one client device associated with the event;
in response to receiving the messaging response data from the at least one client device, determine, by a processing engine, inputting the messaging response data to the processing engine, whether the at least one client device will generate an electronic record associated with the event;
apply, by the processing engine, an algorithm to compare the messaging response data from the at least one client device to stored data of electronic records;
based on a comparison of the messaging response data to the stored data, determine, by application of the algorithm based at least on aggregating messaging response data of the electronic record from at least one client device, a result of a number of electronic records to be generated at a locality in the proximity of the event; and
based at least on the number of electronic records to be generated at the locality within the proximity of the event, determine at least one service from a plurality of services to be allocated to assist in facilitating a processing of electronic records at the locality associated with the event.

10. The system of claim 9, wherein the at least one processor is further configured to:
communicate with the at least one client device using a generative messaging application to solicit the messaging response data related to the event.

11. The system of claim 10, wherein the at least one processor is further configured to:
wherein the generative messaging application is a chatbot; and
initiate a dialogue via the chatbot based on a determination that the at least one client device will generate an electronic record.

12. The system of claim 9, wherein communicating with the at least one client device comprises:
initiate a dialogue via a chatbot to a policyholder associated with a client device, to solicit the messaging response data associated with the event, wherein the dialogue is initiated based on a determination that the policyholder associated with the client device will be generating an electronic record.

13. The system of claim 9, wherein the at least one processor is further configured to:
determine a location for setting up a mobile resource center based on address data of the at least one client device that has been identified in proximity of the event.

14. The system of claim 9, wherein the at least one processor is further configured to:
generate analytical data related to the event, based on output from the algorithm; and
display the analytical data in a graphical user interface to present an allocation of resources available within proximity of the event.

15. The system of claim 14, wherein the at least one processor is further configured to:
receive from a data source, additional event-related data; and
display, within the graphical user interface, dynamic changes in demand responsive to a number of electronic record submissions and locality of electronic record submissions for changing the allocation of resources available within the proximity of the event.

16. One or more non-transitory computer-readable media storing instructions executable by a processor, wherein the instructions, when executed by the processor, cause the processor to perform operations comprising:
receiving, from a plurality of data sources, event-related data;
identifying, at least one client device in proximity of an event based on the event-related data;
communicating with the at least one client device to solicit messaging response data from the at least one client device associated with the event;
in response to receiving the messaging response data from the at least one client device, determining, by a processing engine, inputting the messaging response data to the processing engine, whether the at least one client device will generate an electronic record associated with the event;
applying, by the processing engine, an algorithm to compare the messaging response data from the at least one client device to stored data of electronic records;
based on a comparison of the messaging response data to the stored data, determining, by application of the algorithm based at least on aggregating messaging response data of the electronic record from at least one client device, a result of a number of electronic records to be generated at a locality in the proximity of the event; and
based at least on the number of electronic records to be generated at the locality within the proximity of the event, determining at least one service from a plurality of services to be allocated to assist in facilitating a processing of electronic records at the locality associated with the event.

17. The one or more non-transitory computer-readable media of claim 16, wherein the instructions, when executed by the processor, cause the processor to further perform operations comprising:
communicating with the at least one client device using a generative messaging application to solicit the messaging response data related to the event.

18. The one or more non-transitory computer-readable media of claim 17, wherein the instructions, when executed by the processor, cause the processor to further perform operations comprising:
wherein the generative messaging application is a chatbot; and
initiating a dialogue via the chatbot based on a determination that the at least one client device will generate an electronic record.

19. The one or more non-transitory computer-readable media of claim 16, wherein the algorithm applies a model that comprises a neural network with a set of nodes that comprise a first set of nodes trained on electronic record data, and a second set of nodes trained on data indicative of a policyholder associated with a client device will be submitting an electronic record.

20. The one or more non-transitory computer-readable media of claim 16, wherein the instructions, when executed by the processor, cause the processor to further perform operations comprising:
generating analytical data related to the event, based on output from the algorithm; and
displaying the analytical data in a graphical user interface for presenting an allocation of resources available within proximity of the event.
